(19) United States
(12) Patent Application Publication
(10) Pub. No.: US 2025/0197258 A1
(43) Pub. Date: Jun. 19, 2025

(54) SELECTIVE BUOYANCY POOL DISPENSER LID

(71) Applicant: Thomas Lopez, Phoenix, AZ (US)

(72) Inventor: Thomas Lopez, Phoenix, AZ (US)

(21) Appl. No.: 18/540,972

(22) Filed: Dec. 15, 2023

(51) Int. Cl. C02F 1/68; C02F 1/76; C02F 103/42; E04H 4/12

(52) U.S. Cl. CPC C02F 1/685; C02F 1/76; E04H 4/1281; C02F 2103/42; C02F 2201/004

(57) ABSTRACT

Disclosed herein is a pool dispenser lid that enhances both aesthetic and functional aspects of pool chlorine dispensers. The lid comprises a design element for visual appeal and an air retention element equipped with an adjustable coupling mechanism. This mechanism allows users to selectively vary the amount of air retained within the air retention element, thereby controlling the lid's buoyancy. As a result, the design element can be maintained at a desired level of visibility above the water surface. The adjustable coupling mechanism is versatile, compatible with various types of pool dispensers, and can be configured to utilize threaded, snap-fit, bayonet mount, clamp, band, magnetic, gasket sealing, latch, and pressure or friction fits. This innovation provides a practical solution for enhancing the visual appeal of pool dispensers while offering flexibility in buoyancy control, ensuring the design element is consistently displayed at an user-selected aesthetically pleasing level.

### TECHNICAL FIELD

The present invention relates to the field of swimming pool accessories, specifically to lids for pool chemical dispensers. More particularly, the invention pertains to an improved lid design for pool chlorine dispensers that incorporates both a decorative element and an adjustable buoyancy feature, enhancing both the aesthetic appeal and functional versatility of the dispenser when used in a swimming pool environment.

### BRIEF SUMMARY OF THE INVENTION

The prior art includes pool dispenser lids equipped with design or decorative elements. However, these lids lack the functionality that allows a user to easily and selectively adjust the floating height of the design elements in relation to the water level. Consequently, this limitation often leads to the decorative elements being positioned at visually unappealing levels, detracting from their aesthetic appeal.

The present invention overcomes the aforementioned drawbacks of the prior art by providing a pool dispenser lid designed to offer both functional and aesthetic enhancements for pool chlorine dispensers. The lid comprises a unique combination of a design element and an air retention element, the latter being equipped with an adjustable coupling mechanism. This design allows for the selective variation of the lid's buoyancy when attached to a pool dispenser.

The key innovation of this invention lies in its ability to control the visibility of the design element above the water's surface. By adjusting the coupling mechanism, users can modify the amount of air retained within the air retention element, thereby altering the buoyancy of the lid. This feature ensures that the design element remains visible and aesthetically pleasing, regardless of the water level or the dispenser's position in the pool.

Furthermore, the invention includes various options for the coupling mechanism, including but not limited to threaded, snap-fit, bayonet mount, clamp, band, magnetic, gasket sealing, latch or locking mechanisms, and pressure or friction fits. This versatility allows for compatibility with a wide range of pool dispensers, making the lid adaptable to different sizes and designs.

Furthermore, in the preferred embodiments, the coupling mechanism creates a waterproof seal between the air retention element of the lid and the pool dispenser. This ensures that the design element's position in relation to the water level is maintained over time.

In summary, this invention offers an innovative solution that enhances the visual appeal of pool dispensers while providing flexibility in controlling the buoyancy and visibility of the design element. It represents an improvement over traditional pool dispenser lids, adding both functionality and aesthetic value to swimming pool environments.

### BRIEF DESCRIPTION OF THE DRAWINGS

The invention will be readily understood by the following detailed description in conjunction with the accompanying drawings, wherein like reference numerals designate like structural elements, and in which:

FIG. 1 is a perspective view of a pool dispenser lid and a pool dispenser in accordance with an embodiment of the present invention;

FIG. 2 is a cross sectional view of a pool dispenser lid and a pool dispenser in accordance with an embodiment of the present invention; and,

FIG. 3 is a perspective view of a coupled pool dispenser lid and a pool dispenser in accordance with an embodiment of the present invention.

The drawings described herein are for illustration purposes and are not intended to limit the scope of the present subject matter in any way.

### DETAILED DESCRIPTION

In the following description, to better understand the aforementioned purposes, features, and advantages of the present invention, numerous specific details are set forth in order to provide a thorough understanding of the claimed subject matter. It should be noted that these details and examples are provided to merely aid in understanding the descriptions, and they do not, in any way, limit the scope of the present invention. The present invention can also be implemented in other modes different from those described herein and the present invention is not limited to the specific embodiments disclosed below.

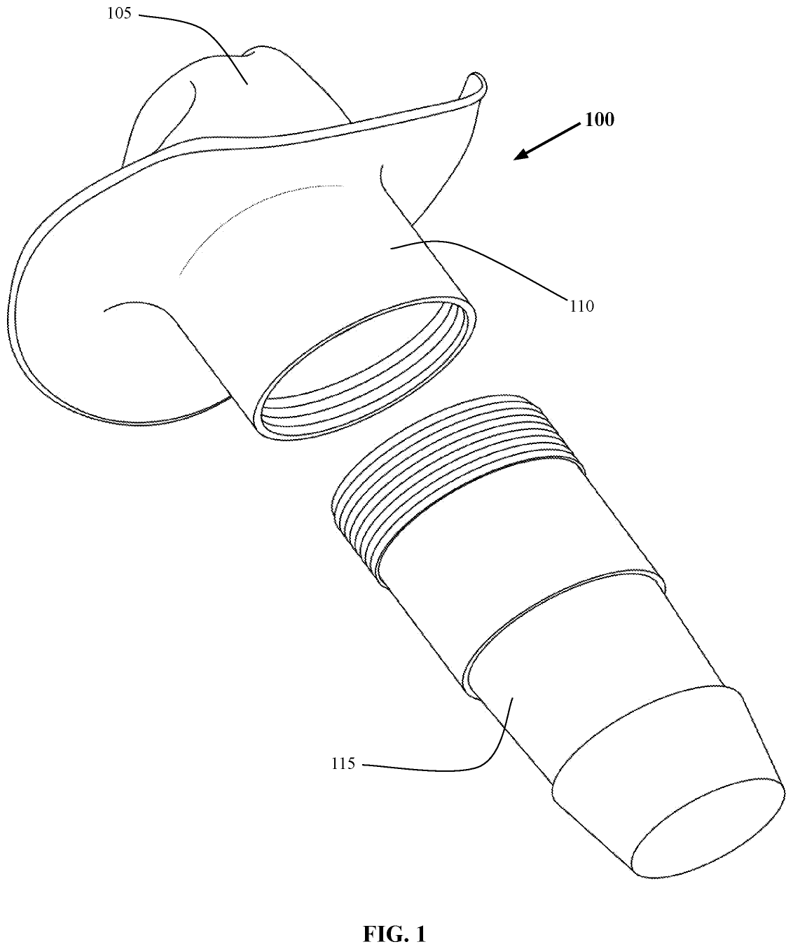

The present invention is described in detail with reference to FIGS. 1, 2, and 3, which illustrate embodiments of a pool dispenser lid and its interaction with a pool dispenser. The invention's primary objective is to provide a pool dispenser lid with an adjustable buoyancy feature to highlight an aesthetic design element.

In FIG. 1, the pool dispenser lid 100, is shown in conjunction with a pool dispenser 115. The lid 100 comprises a design element 105 displayed on its top surface. Below the design element 105 is an air retention element 110, that, based on the amount of air selectively retained in its interior chamber, determines the buoyancy of the lid 100. The pool dispenser 115 is designed to receive the lid 100 and securely hold it in place.

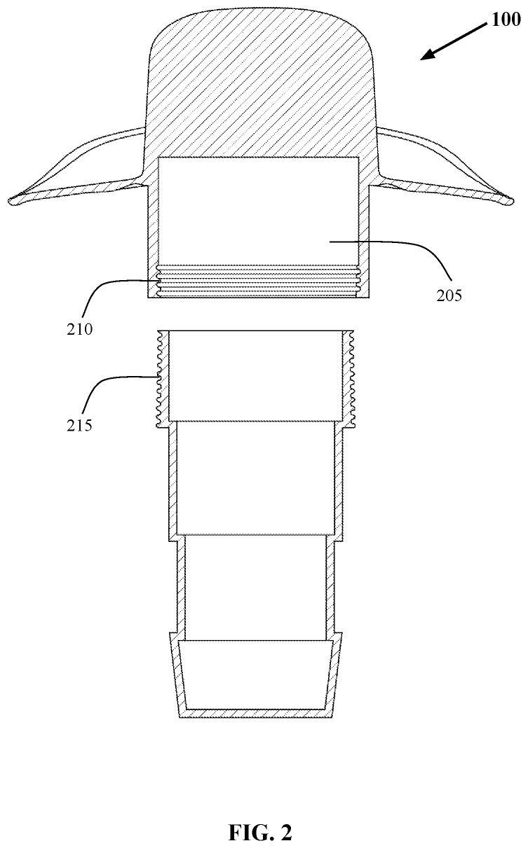

FIG. 2 provides a cross-sectional view, showing the internal structure of the lid and dispenser. The air retention element is depicted containing retained air 205, which is essential for providing buoyancy. The coupling mechanism between the lid 1 and the dispenser is illustrated through internal threading 210 on the lid and corresponding external threading 215 on the dispenser. This threaded connection allows for adjustable attachment based on how deeply the dispenser is screwed into the lid, enabling the user to control the amount of air 205 retained within the air retention element 110, and thereby adjusting the buoyancy of the lid 100.

In the preferred embodiment, the coupling mechanism results in a waterproof seal between the lid and the dispenser to ensure that the overall buoyancy of the combination remains consistent.

In some embodiments, the coupling mechanism is non-adjustable. In these instances, when the lid is coupled with the dispenser, the amount of air retained within the air retention element is fixed. These embodiments are especially well-suited for use with dispensers having a predetermined buoyancy, such as those manufactured by the same entity that produces the lids. In such cases, the air retention element is designed with predetermined air retention capabilities based on the physical characteristics of the design element. This ensures that the design element consistently floats at an optimal height above the water level.

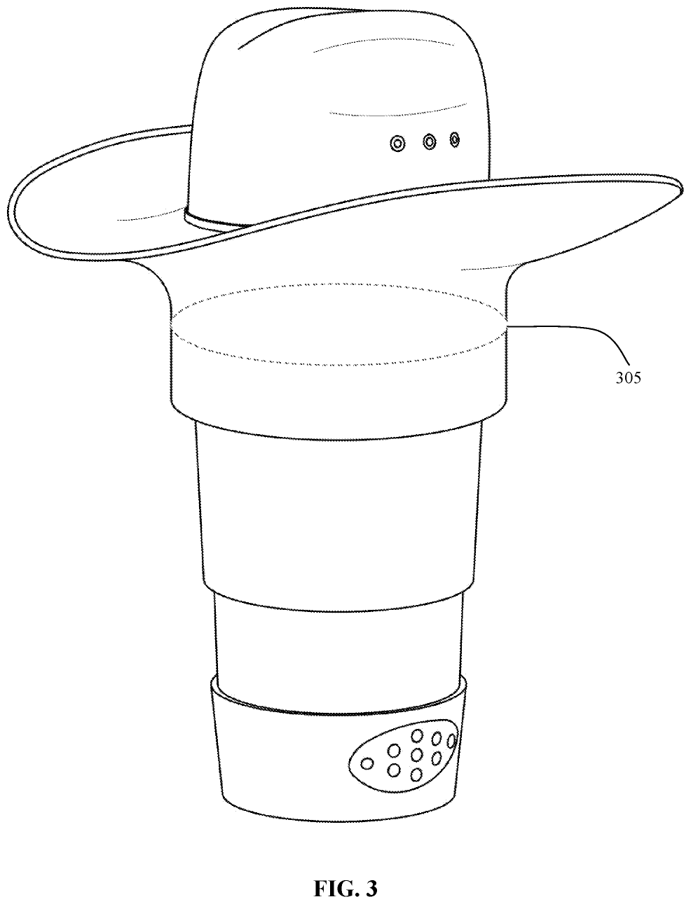

In FIG. 3, the lid is shown attached to the pool dispenser in an example pool environment with a water level 305. The adjustability of the air retention element, as facilitated by the threaded coupling, allows the lid (and consequently the design element) to float at a desired level relative to the water level 305. This ensures that the design element remains visible and aesthetically appealing, floating at or above the water surface, regardless of the amount of chlorine remaining in the dispenser.

Although the drawings only depict a threaded coupling mechanism, other embodiments of the invention could employ various coupling methods, including threaded, snap-fit, bayonet mount, clamp, band, magnetic, and gasket sealing. Additionally, latch or locking, pressure fit, friction fit, combinations of these, or any other well-known coupling mechanisms in the art are also applicable.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

I claim:

1. A pool dispenser lid comprising:
a design element; and,
an air retention element with an adjustable pool dispenser coupling mechanism;
wherein, the adjustable coupling mechanism allows for selective variation of the air quantity retained within the air retention element, thereby enabling control over the buoyancy of the lid to achieve a desired level of visibility of the design element above a water surface when the lid is coupled to a pool dispenser.

2. The pool dispenser lid of claim 1, wherein the buoyancy of the lid, when coupled with a pool dispenser, is adjustable, such that the design element is capable of floating at, or above, the water surface.

3. The pool dispenser lid of claim 1, wherein the adjustable pool dispenser coupling mechanism is selected from the group consisting of: threaded coupling, snap-fit coupling, bayonet mount, clamp coupling, band coupling, magnetic coupling, gasket sealing, latch or locking mechanism, pressure fit, friction fit, and combinations thereof.

4. A pool dispenser lid comprising:
a design element; and,
an air retention element with a pool dispenser coupling mechanism;
wherein, the air retention element is configured to provide sufficient buoyancy to the lid, such that when the lid is coupled with a pool dispenser, the buoyancy enables the design element to float at, or above, the water surface.

5. The pool dispenser lid of claim 4, wherein the adjustable pool dispenser coupling mechanism is selected from the group consisting of: threaded coupling, snap-fit coupling, bayonet mount, clamp coupling, band coupling, magnetic coupling, gasket sealing, latch or locking mechanism, pressure fit, friction fit, and combinations thereof.

6. A pool dispenser system comprising:
a design element;
an air retention element with an adjustable pool dispenser coupling mechanism; and,
a pool dispenser;
wherein, the air retention element is configured to provide sufficient buoyancy to the lid, such that when the lid is coupled with the pool dispenser, the buoyancy enables the design element to float at, or above, the water surface.

7. The pool dispenser system of claim 6, wherein the adjustable coupling mechanism allows for selective variation of the air quantity retained within the air retention element when coupling the air retention element to the pool dispenser, thereby enabling control over the buoyancy of the lid to achieve a desired level of visibility of the design element above a water surface when the lid is coupled to a pool dispenser.

8. The pool dispenser system of claim 7, wherein the adjustable pool dispenser coupling mechanism is selected from the group consisting of: threaded coupling, snap-fit coupling, bayonet mount, clamp coupling, band coupling, magnetic coupling, gasket sealing, latch or locking mechanism, pressure fit, friction fit, and combinations thereof.
